(19) United States
(12) Patent Application Publication
(10) Pub. No.: US 2007/0132831 A1
(43) Pub. Date: Jun. 14, 2007

(54) Masking to prevent overexposure and light spillage in microarray scanning

(75) Inventor: Daniel Y. Chu, Hercules, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA (US)

(21) Appl. No.: 11/302,695

(22) Filed: Dec. 13, 2005

(51) Int. Cl. B41J 15/14

(52) U.S. Cl. 347/241

(57) ABSTRACT

Scanning of a microarray is performed through a mask that exposes a plurality, but not all, of the sites of the microarray, and either the mask is movable relative to the microarray or the microarray is movable relative to the mask, or both. The mask is useful as a means of restricting the illumination of sites on the microarray to those that can be illuminated while the scan head is traveling at a steady, target velocity, blocking the passage of light between the scan head and the microarray at those points in the scan head trajectory where the scan head is either accelerating or decelerating. The mask is also useful for reducing background noise in the microarray image by preventing light spillage to sites adjacent to those being scanned.

### BACKGROUND OF THE INVENTION

1. Field of the Invention

This invention relates to scanning systems for microarrays of biological species such as nucleic acids and proteins, and in general to illumination systems for any type of procedure that involves the individual and sequential illumination of a large number of sites arranged in a spatial array.

2. Description of the Prior Art

Microarrays are two-dimensional arrays of sites where chemical or biochemical assays are performed, each site often being of microscopic dimensions, with an independent assay and often a different molecular species at each site. Microarrays are formed on a variety of substrates, including glass slides, microtiter plates, and membranes. Microarrays are commonly used for example in binding assays for identifying, determining the binding affinity of, or otherwise characterizing unknown biological species. The size, number and spacing of the sites in a microarray can vary considerably. When the sites are wells in a standard microtiter plate, the wells will be 96 in number in a 12×8 array with a spacing between wells of 9 mm. When the sites are spots applied to a glass slide, which is typically 25 mm in width, by automated microprinting techniques, the number of sites can be in the thousands. For gene assays, a single glass slide will typically contain as many as 10,000 genes.

Imaging of the microarray for purposes of monitoring and detection of each assay is achieved by scanning, and in many methodologies, the scanning process includes illumination of each site of the microarray with excitation light. To accomplish this, the scanner head moves in reciprocating strokes across the microarray, each stroke having a velocity profile that includes deceleration at each end of the stroke prior to the reversal of direction, followed by an acceleration after the reversal of direction to bring the head back up to speed for the next stroke. Excitation is typically achieved by a laser which, to serve as a stable light source, is preferably left on for the entire duration of the scan. If sites of the microarray extend to the ends of the path of travel of the scanner head, the use of an uninterrupted laser beam can cause certain sites to receive greater exposure than others. This can lead to overexposure or photobleaching of the site contents. In addition, regardless of whether the laser beam is left on continuously or turned off at the ends of each stroke, a certain degree of light spillage to adjacent wells occurs, either by diffusion, reflection or refraction, when the laser is focused on any single well. Light spillage of this nature can occur between rows as well as within a row, particularly when the path of travel of the scanner head exceeds the width of the row. Light spillage can also occur when a single stroke covers only a portion of a row, with spillage onto portions of the row that are not being scanned. In all cases, the spillage causes undesirable overexposure or generates background noise among the scanning signals, or both.

### SUMMARY OF THE INVENTION

These and other limitations of the prior art are addressed by the present invention, which resides in a microarray scanning illumination system that includes a sample support, a reciprocating-motion scan head, and a mask positioned between the sample support and the scan head, the mask blocking all light from passing from the scan head to the sample support other than through an opening in the mask that exposes only the sites to be scanned in a single stroke of the scan head or a series of parallel strokes. Defining the scanning direction along a single row as the x-axis, the width of the opening parallel to the x-axis in certain embodiments of the invention is sufficient to expose more than one, but less than all, of the sample sites in a row, and is shorter in length than the path of travel of the scan head in a single stroke of the reciprocating movement of the scan head. With the mask appropriately sized and positioned, light from the scan head will be blocked and thus prevented from reaching the microarray at the two ends of the path of travel where the scan head is decelerating or accelerating to reverse its direction. In certain embodiments as well, the mask can also be sized and positioned to expose only one row, or a portion of only one row, of sites in the microarray, thereby preventing spillage of light onto adjacent rows. The mask is particularly useful when the scan head traverses only a portion of a row in a single stroke but can be shifted to another portion or the remainder of the row at a later stage of the imaging process to complete a scan of the entire row. In general, the present invention resides in the use of the mask to prevent the unwanted illumination of sites not being scanned, or to prevent nonuniform exposure of sites due to the end effects of the reciprocating motion of the scan head, or to prevent both. In all cases, the mask is movable relative to the microarray, or vice versa, to expose different groups of sites to the scan head as needed to provide a complete scan of the microarray.

These and other objects, features, advantages, and embodiments of the invention will become apparent from the description that follows.

### BRIEF DESCRIPTION OF THE DRAWINGS

FIG. 1 is a diagram representing a microarray scanning system in accordance with the present invention in a side view.

FIG. 2 is a diagram representing a microarray and mask to illustrate the method of the present invention.

FIG. 3 is a further diagram representing a microarray and mask illustrating the method of the present invention.

### DETAILED DESCRIPTION OF THE INVENTION AND PREFERRED EMBODIMENTS

The sequence in which the sites of the microarray are illuminated by the light source during the scanning process path is referred to herein as the scanning protocol, and is determined by the length of each stroke of the scan head (to which the light source is affixed) during the reciprocating, i.e., back-and-forth, motion of the scan head, in conjunction with the incremental movements of the microarray to align the scan head with successive rows of sample sites on the microarray and all other movements of the scan head, mask, and microarray needed to complete the scanning of the entire microarray. While individual protocols can vary depending on the configuration and dimensions of the microarray, all protocols will include reciprocating motion of the scan head along the x-axis for each row of the microarray. While a uniform scan head speed would provide the most even distribution of illumination among the sample sites along the path of travel, absolute uniformity is not achievable. Instead, because the scan head driver must reverse the direction of the scan head at each end of its path of travel, reciprocating scan heads undergo a deceleration at each end of each stroke followed by acceleration in the reverse direction. Typical of the drivers used for scan heads are moving coil actuators, which utilize the well-known Lorentz force that results from an alternating current passing through an electric coil in a magnetic field. Moving coil actuators are also referred to as voice coil actuators, and examples of these actuators that are in current use are those supplied by the Kimco Magnetics Divison of BEI Technologies, Inc., San Marcos, Calif., USA, and by H2W Technologies, Inc., Valencia, Calif., USA. Disclosures of voice coil actuators are found in U.S. Pat. Nos. 6,894,408, 6,870,285, 6,815,846, and 6,787,943. Further voice coil actuators are described in commonly owned, co-pending U.S. patent application Ser. No. 11/265,000, filed Nov. 1, 2005, inventors Paul J. Patt et al., entitled “Moving Coil Actuator for Reciprocating Motion With Controlled Force Distribution,” and commonly owned, co-pending U.S. patent application Ser. No. 11/______, filed Nov. 30, 2005, inventor Daniel Y. Chu, entitled “Moving Coil Actuator with Expandable Range of Motion.” The contents of each of these documents are incorporated herein by reference. In scanning systems that incorporate any of these actuators, movement of the scan head is caused by movement of the coil which itself is a response to an electromagnetic force. While the velocity profile over the path of travel of the coil will vary with the magnitude of the electric potential, the configuration of the coil, and the sizes and relative positions of the coil and the magnet, the profiles for all such coils include deceleration and acceleration at the limits of travel, as noted above, for each row.

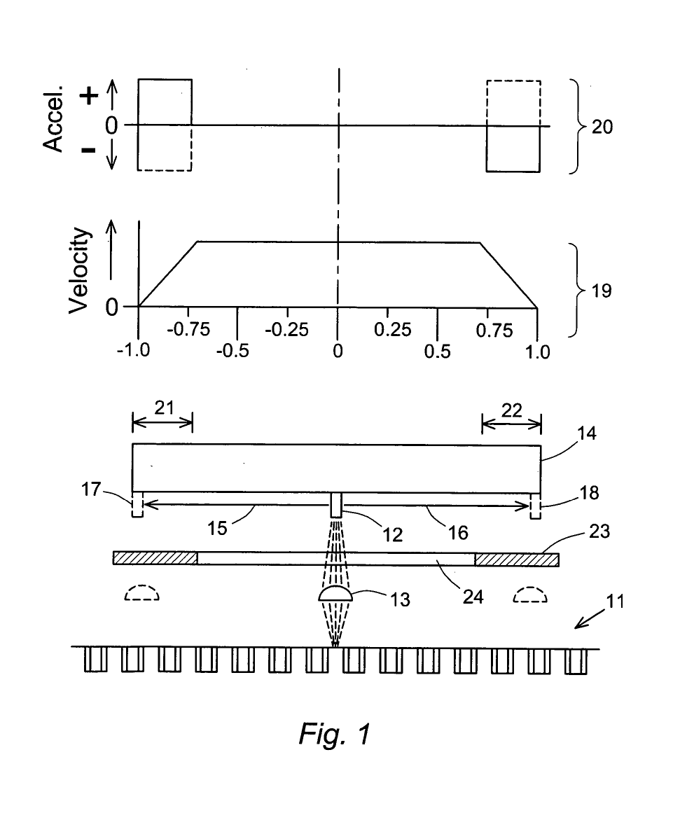

The travel path of the scan head during one stroke of the reciprocating motion is shown in FIG. 1, where a microarray 11 is shown in position below a scan head 12 and a focusing lens 13 that is part of the scanning unit and travels with the scan head 12. The components are not drawn to scale and their spacing is exaggerated for ease of understanding. The microarray 11 in this case is represented by a multi-well plate that has been inverted, and the sites to be illuminated are the analytes in each well that have been deposited on and become adhered to the transparent glass bottoms of the wells prior to the inversion. This inversion of the plate with illumination through the glass permits the use of a scan head lens 13 with a short focal length, as low as 1.7 mm, for example, and its placement in close proximity to each site as the scan head and lens travel through each stroke. The scan head 12 and lens 13 are mounted to a moving coil actuator 14 that serves as a representative example of a driver for the scanning unit. The actuator drives the scan head 12 and lens 13 in a reciprocating motion along the x-axis as indicated by the arrows 15, 16 and are shown in solid lines at the midpoint of the path of travel and in dashed lines at the two extremes 17, 18 of the path of travel. The velocity profile 19 and the acceleration profile 20 of the scan head and lens are shown directly above the actuator, with the horizontal axis of each profile representing the distance along the path of travel and arranged in alignment with the travel range of the scan head 12. (The profiles are approximations.) As the velocity profile 19 indicates, the velocity ranges from zero to a target velocity in a segment at each end 21, 22 of the scan head trajectory and the velocity is maintained relatively constant at the target level between the two end segments. In the acceleration profile 20, the left-to-right travel is indicated by the solid line, with a positive acceleration at the left end 21 of the trajectory and a negative acceleration (i.e., deceleration) at the right end 22. Travel in the reverse (right-to-left) direction is indicated by the dashed line which includes a positive acceleration at the right end 22 and a negative acceleration at the left end 21.

The mask 23 is positioned between the scan head 12 and the microarray 11, and preferably between the scan head 12 and the focusing lens 13 to obtain maximal benefit of the short focal length of the lens. The mask has a window or opening 24 that is centered between the two ends 21, 22 of the trajectory of the scan head. The width of the window 24 in this embodiment is approximately equal to the width of the central portion of the trajectory in which the velocity is at its target value. As a result, the scan head 12 and lens 13 are aligned with the window 24 only when the scan head and lens are moving at the target velocity, and all sites of the microarray that are not blocked by the mask 24 will be illuminated uniformly for a uniform duration of time since the scan head and lens pass each one at the same speed. The mask thus eliminates the overexposure that is achieved during the portions of the scan head travel in which deceleration and acceleration occur.

While the reciprocating motion is along the x-axis within individual rows, scanning of different rows in succession is achieved by incremental advances along the y-axis between strokes along the x-axis. The y-axis advances can be achieved by moving either the microarray or the scan head, actuator and mask. While scanning profiles can vary, the typical and preferred profile begins with a scan of sites in one row in a single direction along the x-axis, followed by an incremental advance of the microarray or scanning head along the y-axis to the next adjacent row, followed by a scan of sites of the new row along the x-axis in the direction opposite to that of the scan in the first row. The rows are thus scanned in alternating directions along the x-axis with incremental advances along the y-axis between each x-axis scan. For this scanning protocol, the mask window 24 can be just large enough to expose sites within only one row, requiring the mask and scanner to be moved together along the y-axis between each single row scan. Alternatively, the mask window 24 can be large enough to expose sites of two or more adjacent rows simultaneously, in which case the mask need only be moved after all rows exposed by the window have been scanned.

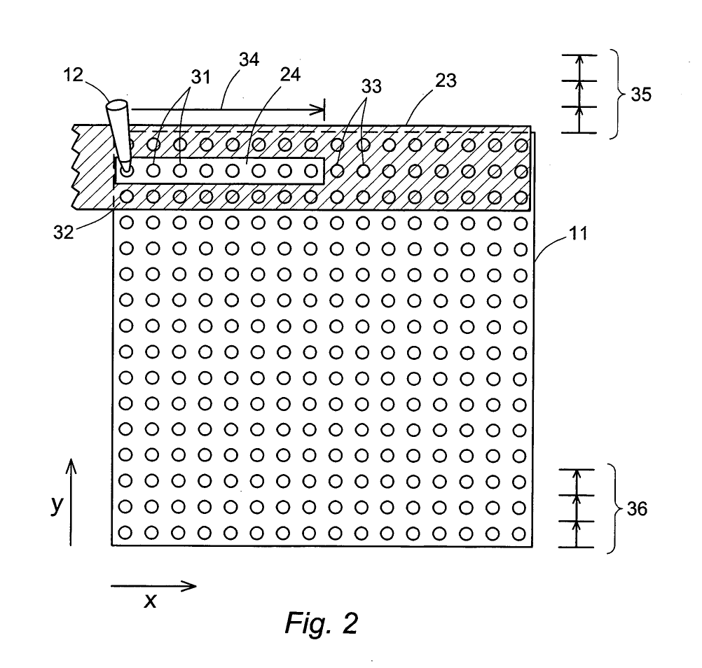

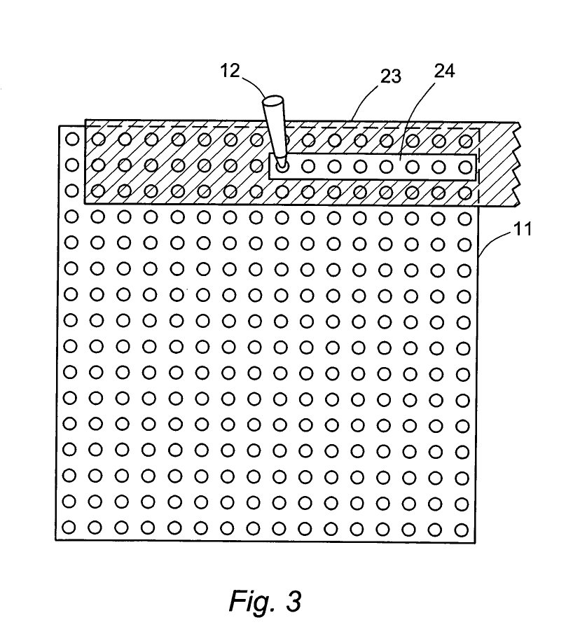

While the blocking of the scan head during acceleration and deceleration eliminates overexposure, a mask in accordance with this invention will also reduce or eliminate light spillage to sites not being scanned in a particular stroke. Light spillage arises in adjacent rows when a particular row is being scanned and also in adjacent portions of the same row when only a portion of a row is being scanned. FIGS. 2 and 3 illustrate a mask 23 in accordance with this invention positioned over a microarray 11. The scan head 12 is also shown in each Figure, but the lens is omitted to simplify the illustration. The lens will travel with the scan head and both will be joined to the moving coil of the actuator. Alternatively, the lens will be joined to the scan head either by a linkage extending through the mask opening or around the edge of the mask. As noted above, the microarray 11 may be retained on a glass slide, multi-well assay plate, membrane or the like. The microarray shown in FIGS. 2 and 3 is a representative example with a 16×16 array of sites.

In the views shown in FIGS. 2 and 3, the “rows” in the microarray are horizontal and the “columns” are vertical. The mask window 24 exposes a portion of one row, specifically eight of the sixteen sites in the row. In FIG. 2, the sites 31 to be scanned are those exposed by the mask, and the mask prevents light spillage onto the sites 32 in the adjacent row and onto the sites 33 in the same row that are not being scanned. Scanning occurs along the x-axis as indicated by the arrow 34. Advancement to successive rows in this example is achieved by incremental movements of the microarray along the y-axis relative to the mask 23 and the scanning components, as indicated by the arrows 35, 36. Scanning of the remaining eight sites in each row is achieved by shifting the mask and scanning unit, including the scan head, lens, and actuator, in the x-direction relative to the microarray, or by moving the microarray relative to the scanning unit, to achieve the relative positions shown in FIG. 3. Stepper motors, dc motors, and other conventional motors can be used to move these components for all movements other than the reciprocating movements of the scan head, i.e., for movements indicated by the arrows 35, 36 in FIG. 2 and for movements to achieve the shift along the x-axis between the positions shown in FIGS. 2 and 3. Once the components are in the position shown in FIG. 3, scanning is performed as described above in connection with FIG. 2.

The mask in each of these embodiments can be constructed of conventional materials well known among those skilled in the art. Any material that is non-transmissive and non-reflective of light can be used, and the window can either be an opening (i.e., a void), or a transparent material. The mask can be rigidly secured to the scan driver so that the two move together while allowing the scan head and lens to move relative to the mask. Alternatively, the mask can be independently movable.

As noted above, moving coil actuators are preferred as drivers for the scan head. Scanning systems with relatively short scan distances that are capable of scanning portions of rows as illustrated by FIGS. 2 and 3 are of particular interest since the economic advantage of these systems due to the small size and light weight of their components can be partially offset by the disadvantage of overexposure at the ends of each stroke as well as by light spillage to sites beyond the ends of the stroke. One example of a moving coil actuator that is designed to operate in this manner with a short scan while being movable to different segments of a microarray is disclosed in commonly owned, co-pending U.S. patent application Ser. No. 11/______, filed Nov. 30, 2005, inventor Daniel Y. Chu, entitled “Moving Coil Actuator with Expandable Range of Motion,” the contents of which are incorporated herein by reference. The actuator of the Chu application contains a movable magnet assembly that shifts the range of motion of the coil. As in moving coil actuators in general, the actuator of the Chu application includes a coiled electrical conductor and a magnet assembly with magnetic poles separated by a gap large enough to receive the coiled conductor and to allow the conductor to move in a reciprocating manner. The coil is mounted to a carrier and is connected to a power source that produces an electric current of alternating direction through the coil. The magnet assembly moves between two or more positions along a path of travel that is parallel to the path of travel of the reciprocating motion of the coil. The scanning range of the coil can thus be shifted by distances equal to the separation between the various positions of the magnet assembly. The coil and magnet assembly are moved independently, and each is operated while the other is held stationary. The magnet assembly can thus be held at a location that allows movement of the coil over a portion of the microarray while the coil is moved within that portion, then shifted to a different location corresponding to another portion of the microarray and the coil moved within that portion. With a sufficient number of shifts, the microarray is scanned across its full width.

Further variations and embodiments will be apparent to those skilled in the art of microarray scanning who have studied the drawings and descriptions offered above. In addition to variations in the configurations and geometries of the mask, scan head and driver, for example, a variety of scanning protocols and operating conditions, all within the scope of this invention, will be readily apparent to the skilled engineer.

What is claimed is:

1. A scanning illumination system for a microarray, comprising:
a sample support comprising spatially separated sample sites arranged in a two-dimensional microarray consisting of rows of selected width along an x-axis and columns of selected length along a y-axis;
a scan head comprising a light source;
x-axis scanning means for moving said scan head relative to said sample support in a reciprocating motion along a path of travel parallel to said x-axis;
a mask positioned between said sample support and said scan head, said mask blocking passage of light from said light source to said sample support other than through a window having a width parallel to said x-axis that exposes a plurality of sample sites in a row and is shorter in length than said path of travel of said scan head; and
shifting means for varying said sample sites that are exposed through said window by moving either (i) said mask relative to said sample support and scan head or (ii) said sample support and scan head relative to said mask.

2. The scanning illumination system of claim 1 wherein said window exposes more than one, but less than all, of said sample sites in a row, and said shifting means is x-axis shifting means for moving either (i) said mask along said x-axis relative to said sample support and scan head or (ii) said sample support and scan head along said x-axis relative to said mask.

3. The scanning illumination system of claim 1 wherein said shifting means moves said mask along said x-axis relative to said sample support and scan head.

4. The scanning illumination system of claim 1 wherein said shifting means moves said sample support and scan head along said x-axis relative to said mask.

5. The scanning illumination system of claim 1 wherein said window has a length parallel to said y-axis that exposes sample sites of only one of said rows.

6. The scanning illumination system of claim 1 further comprising means for moving said sample support along said y-axis relative to said mask and said scan head.

7. The scanning illumination system of claim 1 wherein said x-axis scanning means causes acceleration and deceleration of said scan head in segments of said path of travel at each end thereof, and said mask blocks passage of light when said scan head is within said segments.

8. The scanning illumination system of claim 1 wherein said x-axis scanning means is a moving coil actuator.

9. The scanning illumination system of claim 1 wherein said x-axis scanning means is a moving coil actuator and said x-axis shifting means is a stepper motor.

10. The scanning illumination system of claim 1 further comprising a focusing lens and wherein said mask is between said scan head and said focusing lens.

11. A method for scanning an array of sites in a two-dimensional microarray consisting of rows of selected width along an x-axis and columns of selected length along a y-axis, said method comprising:
(a) illuminating said microarray with a scan head through a mask that blocks passage of light from said scan head to said microarray other than through a window that exposes a first plurality of sites in a row, while moving said scan head along said x-axis over said plurality of sites along a path of travel that exceeds the width of said window; and
(b) moving said microarray relative to said mask or said mask relative to said microarray to expose a second plurality of sites of said microarray through said window opening, and illuminating sites of said second plurality by moving said scan head along said x-axis;

12. The method of claim 11 wherein said first plurality of sites is more than one, but less than all, of said sites in a row, wherein step (b) comprises moving said microarray along said y-axis relative to said scan head to expose said second plurality of sites, and wherein said method further comprises:
(c) repeating step (b) over a selected number of rows; and
(d) shifting said sample sites that are exposed through said window by moving either (i) said mask along said x-axis relative to said microarray and scan head or (ii) said microarray and scan head along said x-axis relative to said mask.

13. The method of claim 12 wherein step (d) comprises moving said mask along said x-axis relative to said microarray and scan head.

14. The method of claim 12 wherein step (d) comprises moving microarray and scan head along said x-axis relative to said mask.

15. The method of claim 11 wherein said window has a length parallel to said y-axis that exposes sample sites of only one of said rows.

16. The method of claim 11 wherein step (a) comprises accelerating and decelerating said scan head in segments of said path of travel at each end thereof, and said mask blocks passage of light when said scan head is within said segments.

17. The method of claim 11 wherein said moving of said scan head in step (a) is performed by a moving coil actuator.

18. The method of claim 12 wherein said moving of said scan head in step (a) is performed by a moving coil actuator and said shifting of said sample sites of step (d) is performed by a stepper motor.
